(19) United States
(12) Patent Application Publication
(10) Pub. No.: US 2026/0291157 A1
(43) Pub. Date: Sep. 24, 2026

(54) ELECTRICAL CONNECTION MODULE AND CONNECTOR

(71) Applicant: Tyco Electronics (Shanghai) Co., Ltd., Shanghai (CN)

(72) Inventors: Qianjin (Orando) Li, Shanghai (CN); Jie (Roger) Luo, Foshan (CN); Rong (Summer) Zhang, Shenzhen (CN); William (Wei) Yao, Kunshan (CN)

(73) Assignee: Tyco Electronics (Shanghai) Co., Ltd., Shanghai (CN)

(21) Appl. No.: 19/570,396

(22) Filed: Mar. 18, 2026

(30) Foreign Application Priority Data
Mar. 18, 2025 (CN) 202510324435.X

(51) Int. Cl. H01R 25/16

(52) U.S. Cl. CPC H01R 25/16

(57) ABSTRACT

An electrical connection module includes a strip-shaped insulating plate, a first conductive bar, and a second conductive bar. The strip-shaped insulating plate has a top surface and a bottom surface opposite each other and two sides opposite each other. The first conductive bar is fixed on the top surface and has two first side strip portions opposite each other and extending in a longitudinal direction. The second conductive bar is fixed on the bottom surface and has two second side strip portions opposite each other and extending in the longitudinal direction. Two transverse sides of the electrical connection module are respectively inserted into two mating connectors. The two first side strip portions are respectively in electrical contact with first elastic terminals of the two mating connectors. The two second side strip portions are respectively in electrical contact with second elastic terminals of the two mating connectors.

### CROSS-REFERENCE TO RELATED APPLICATION

This application claims the benefit of the filing date under 35 U.S.C. § 119(a)-(d) of Chinese Patent Application No. CN202510324435.X filed on Mar. 18, 2025, the whole disclosure of which is incorporated herein by reference.

### FIELD OF THE INVENTION

The present invention relates to an electrical connection module and, more particularly, to an electrical connection module and a connector.

### BACKGROUND OF THE INVENTION

One side of a busbar connector is used for mating with a mating connector, and the other side of the busbar connector cannot mate with a mating connector. Therefore, the existing busbar connector can generally only be mated on one side and cannot be mated on two sides. This results in requiring an excessive number of busbar connectors. The busbar connectors have a relatively low power density, causing relatively high manufacturing costs and a relatively large size.

### SUMMARY OF THE INVENTION

An electrical connection module includes a strip-shaped insulating plate, a first conductive bar, and a second conductive bar. The strip-shaped insulating plate has a top surface and a bottom surface opposite each other and two sides opposite each other. The first conductive bar is fixed on the top surface and has two first side strip portions opposite each other and extending in a longitudinal direction. The second conductive bar is fixed on the bottom surface and has two second side strip portions opposite each other and extending in the longitudinal direction. Two transverse sides of the electrical connection module are respectively inserted into two mating connectors. The two first side strip portions are respectively in electrical contact with first elastic terminals of the two mating connectors. The two second side strip portions are respectively in electrical contact with second elastic terminals of the two mating connectors.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a transverse sectional view of the connector of FIG. 1;

FIG. 3 is another transverse sectional view of the connector of FIG. 1, in which bolts are shown;

FIG. 4 is a planar sectional view of the connector of FIG. 1, in which bolts are shown;

FIG. 5 is a sectional exploded view of the of FIG. 1;

FIG. 6 is a perspective view of an electrical connection module of the connector of FIG. 1;

FIG. 7 is a transverse sectional view of the electrical connection module of FIG. 6, in which bolts are shown; and

FIG. 8 is a transverse sectional exploded view of the electrical connection module of FIG. 6.

### DETAILED DESCRIPTION

The technical solution of the present invention is further specifically described below by way of embodiments and in conjunction with the accompanying drawings. In the specification, the same or similar accompanying drawing symbols indicate the same or similar components. The following description of the embodiments of the present invention with reference to the accompanying drawings is intended to explain the general inventive concept of the present invention and should not be construed as a limitation of the present invention.

In addition, the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

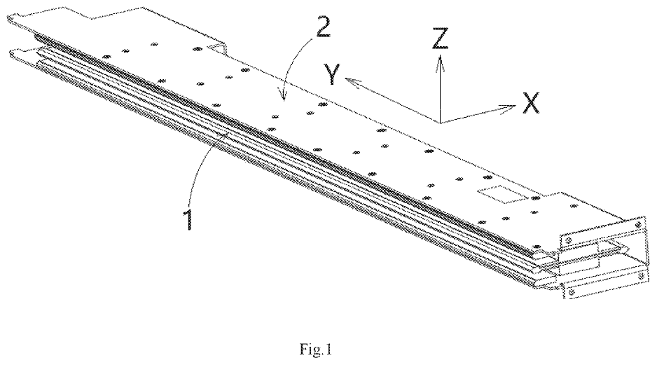

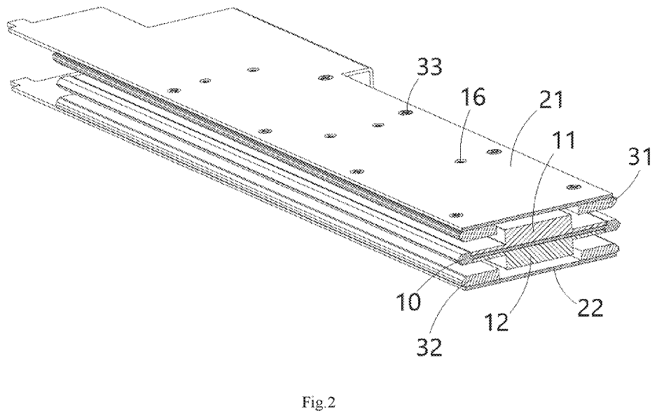

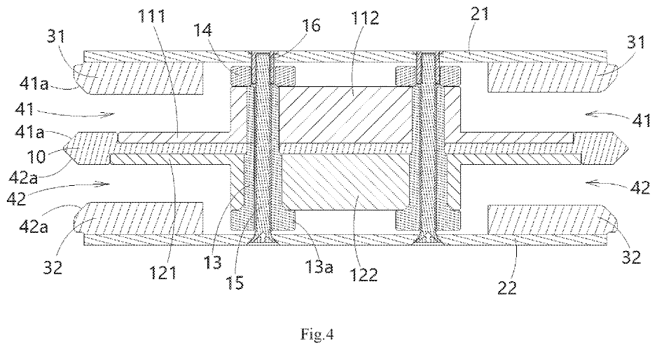

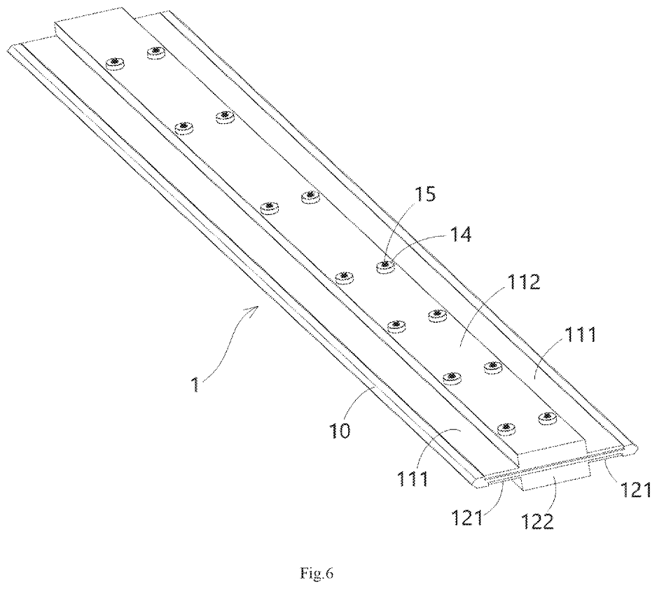

An exemplary embodiment of an electrical connection module 1 will now be described with reference to FIGS. 1-8. As shown in FIGS. 2-3, 5, and 8, the electrical connection module 1 comprises a strip-shaped insulating plate 10, a first conductive bar 11 and a second conductive bar 12. The strip-shaped insulating plate 10 has a top surface and a bottom surface opposite each other in a height direction Z and two sides opposite each other in a transverse direction X thereof. The first conductive bar 11 is fixed on the top surface of the strip-shaped insulating plate 10 and has two first side strip portions 111, as shown in FIGS. 4 and 6-8, opposite each other in the transverse direction X and extending in a longitudinal direction Y. The second conductive bar 12 is fixed on the bottom surface of the strip-shaped insulating plate 10 and has two second side strip portions 121, as shown in FIGS. 4 and 6-8, opposite each other in the transverse direction X and extending in the longitudinal direction Y. Two transverse sides of the electrical connection module 1 are adapted to be inserted into two mating connectors respectively, the two first side strip portions 111 of the first conductive bar 11 are adapted to be in electrical contact with first elastic terminals of the two mating connectors respectively, and the two second side strip portions 121 of the second conductive bar 12 are adapted to be in electrical contact with second elastic terminals of the two mating connectors respectively.

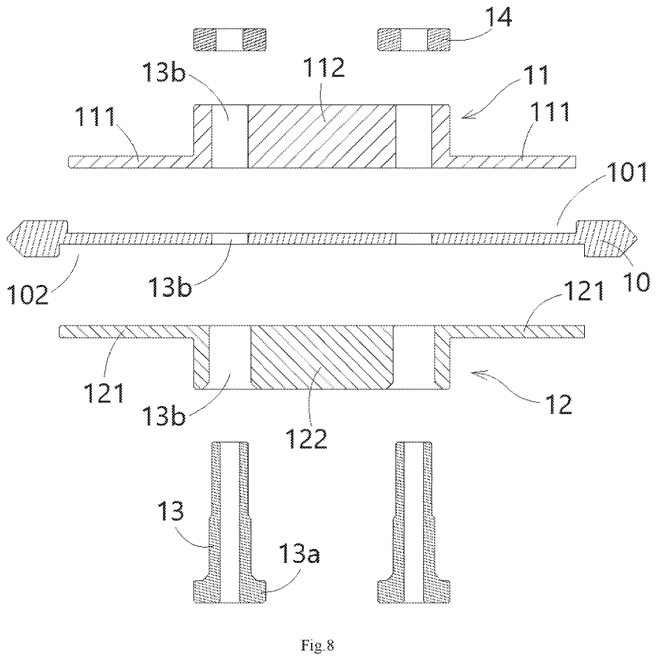

As shown in FIG. 8, a first mounting groove 101 extending in the longitudinal direction Y is formed in the top surface of the strip-shaped insulating plate 10. The first conductive bar 11 is embedded in the first mounting groove 101. A second mounting groove 102, as shown in FIG. 8, extending in the longitudinal direction Y is formed in the bottom surface of the strip-shaped insulating plate 10. The second conductive bar 12 is embedded in the second mounting groove 102.

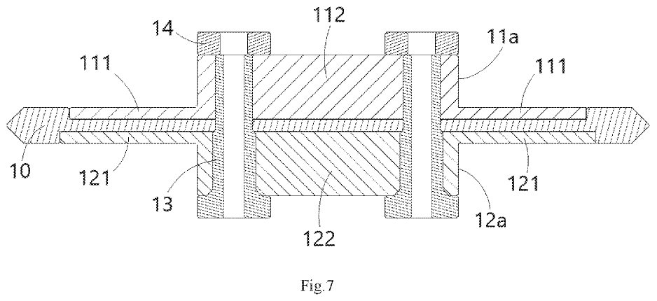

The first conductive bar 11 further has a first protrusion 112, as shown in FIGS. 4 and 6-8, located between the two first side strip portions 111 and protruding from the first mounting groove 101. The first protrusion 112 has two first side surfaces 11a, as shown in FIG. 7, opposite each other in the transverse direction X. The two first side surfaces 11a of the first protrusion 112 are perpendicular to the transverse direction X and adapted to abut against end surfaces of first plugs of the two mating connectors, respectively.

The second conductive bar 12 further has a second protrusion 122, as shown in FIGS. 4 and 6-8, located between the two second side strip portions 121 and protruding from the second mounting groove 102. The second protrusion 122 has two second side surfaces 12a, as shown in FIG. 7, opposite each other in the transverse direction X. The two second side surfaces 12a of the second protrusion 122 are perpendicular to the transverse direction X and adapted to abut against end surfaces of second plugs of the two mating connectors, respectively.

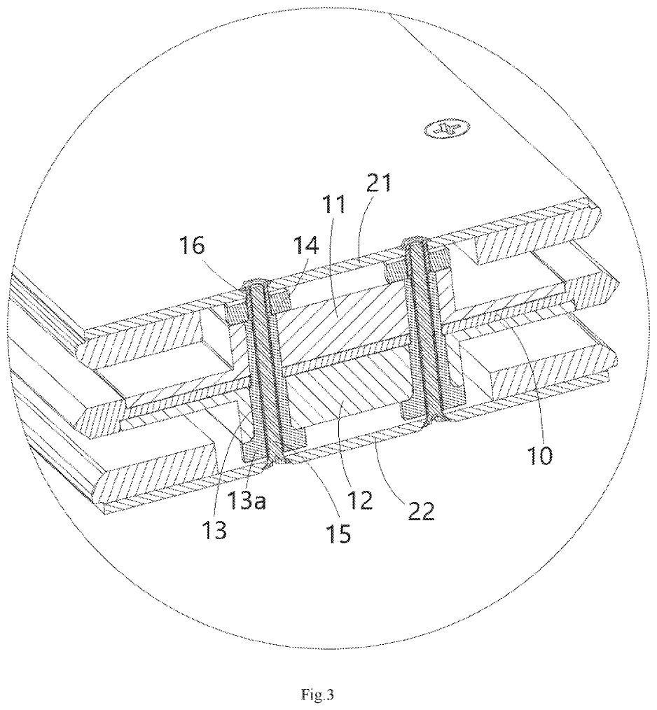

As shown in FIG. 8, a plurality of mounting through holes 13b are formed in each of the strip-shaped insulating plate 10, the first protrusion 112 of the first conductive bar 11, and the second protrusion 122 of the second conductive bar 12. The plurality of mounting through holes 13b are spaced apart in the transverse direction X and the longitudinal direction Y. The electrical connection module 1 further comprises a plurality of insulating cylinders 13, as shown in FIGS. 3-4 and 7-8, passing through the plurality of mounting through holes 13b, respectively. As shown in FIGS. 3-4, the insulating cylinders 13 have central through holes allowing bolts 15 to pass through, enabling the electrical connection module 1 to be fastened to an outer shielding shell 2 of a connector by means of the bolts 15 passing through the insulating cylinders 13.

The strip-shaped insulating plate 10 is configured to electrically isolate the first conductive bar 11 from the second conductive bar 12, and the insulating cylinder 13 is configured to electrically isolate the bolt 15 from the first conductive bar 11 and the second conductive bar 12.

As shown in FIGS. 3-4 and 8, the insulating cylinder 13 has a flange portion 13a located at one end thereof. The flange portion 13a is positioned on a bottom surface of the second protrusion 122 of the second conductive bar 12 and configured to electrically isolate the second protrusion 122 of the second conductive bar 12 from a bottom wall 22 of the outer shielding shell 2.

As shown in FIGS. 3-4 and 6-8, the electrical connection module 1 further comprises a plurality of insulating washers 14. Each of the plurality of insulating washers 14 are located at the other end of each of the plurality of insulating cylinders 13 and positioned on a top surface of the first protrusion 112 of the first conductive bar 11. The plurality of insulating washers 14 are configured to electrically isolate the first protrusion 112 of the first conductive bar 11 from a top wall 21 of the outer shielding shell 2.

The first conductive bar 11 and the second conductive bar 12 are copper bars or copper alloy bars.

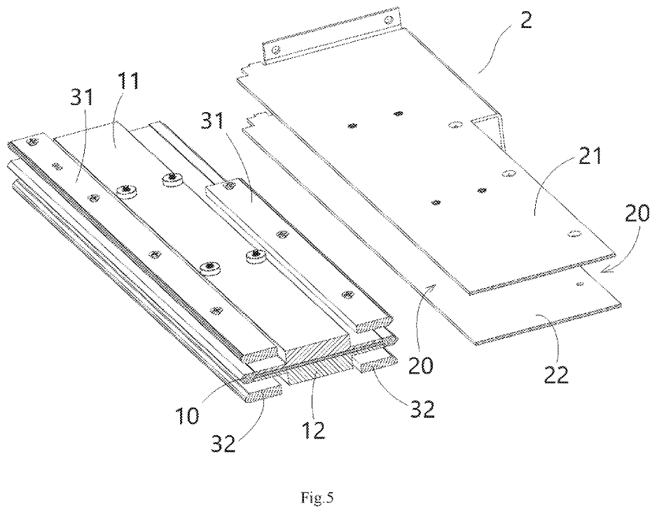

An exemplary embodiment of a connector will now be described with reference to FIGS. 1-8. As shown in FIG. 1, the connector comprises an outer shielding shell 2, the above electrical connection module 1, and a connecting assembly. The electrical connection module 1 is disposed in the outer shielding shell 2. The connecting assembly fixes the electrical connection module 1 to the outer shielding shell 2. The outer shielding shell 2 has two side openings 20, as shown in FIG. 5, opposite each other in a transverse direction X thereof to allow insertion of two mating connectors respectively, and two transverse sides of the electrical connection module 1 are adapted to mate with the inserted two mating connectors, respectively.

As shown in FIGS. 2-5, the outer shielding shell 2 has a top wall 21 and a bottom wall 22 opposite each other in a height direction Z thereof. The first conductive bar 11 and the second conductive bar 12 of the electrical connection module 1 face the top wall 21 and the bottom wall 22 of the outer shielding shell 2, respectively. The connecting assembly comprises a plurality of threaded cylinders 16, as shown in FIGS. 2-4, and a plurality of bolts 15, as shown in FIGS. 3-4 and 6. The plurality of threaded cylinders 16 are riveted to the top wall 21 of the outer shielding shell 2. The plurality of bolts 15 pass through the bottom wall 22 of the outer shielding shell 2 and pass through the plurality of insulating cylinders 13 of the electrical connection module 1, respectively. Internal threads are formed in the threaded cylinders 16, and the plurality of bolts 15 are threadably connected to the plurality of threaded cylinders 16 respectively to fix the electrical connection module 1 to the outer shielding shell 2.

As shown in FIGS. 3-4, the plurality of threaded cylinders 16 are inserted into a plurality of insulating washers 14 of the electrical connection module 1, respectively. The insulating washers 14 electrically isolate the threaded cylinders 16 from the first conductive bar 11 and electrically isolate the first conductive bar 11 from the top wall 21 of the outer shielding shell 2. The flange portions 13a of the insulating cylinders 13 electrically isolate the second conductive bar 12 from the bottom wall 22 of the outer shielding shell 2.

As shown in FIGS. 2 and 4-5, the connector further comprises two upper insulators 31 and two lower insulators 32. The two upper insulators 31 are disposed in the outer shielding shell 2 and fixed to an inner side of the top wall 21 of the outer shielding shell 2. The two lower insulators 32 are disposed in the outer shielding shell 2 and fixed to an inner side of the bottom wall 22 of the outer shielding shell 2. The two upper insulators 31 face two first side strip portions 111 of the first conductive bar 11, respectively. A first slot 41, as shown in FIG. 4, allowing insertion of a first plug of the mating connector is defined between the first side strip portion 111 of the first conductive bar 11 and the upper insulator 31 facing the first side strip portion 111. The two lower insulators 32 face two second side strip portions 121 of the second conductive bar 12 respectively, and a second slot 42, as shown in FIG. 4, allowing the insertion of a second plug of the mating connector is defined between the second side strip portion 121 of the second conductive bar 12 and the lower insulator 32 facing the second side strip portion 121.

As shown in FIG. 4, a first guide bevel 41a is formed on each of the upper insulator 31 and an upper side edge of the strip-shaped insulating plate 10. The first guide bevels 41a define a first flared inlet which is open toward the outside, to guide the insertion of the first plug of the mating connector into the first slot 41. A second guide bevel 42a, as shown in FIG. 4, is formed on each of the lower insulator 32 and a lower side edge of the strip-shaped insulating plate 10. The second guide bevels 42a define a second flared inlet which is open toward the outside, to guide the insertion of the second plug of the mating connector into the second slot 42.

As shown in FIG. 2, the upper insulator 31 is fixed to the inner side of the top wall 21 of the outer shielding shell 2 by a plurality of screws 33, and the lower insulator 32 is fixed to the inner side of the bottom wall 22 of the outer shielding shell 2 by a plurality of screws 33.

In the aforementioned exemplary embodiments according to the present invention, the connector can mate with a mating connector on two sides. Therefore, the number of connectors that are required can be reduced, and the power density of the connectors can be doubled, such that the manufacturing costs and the size of a product can be reduced.

It should be appreciated for those skilled in this art that the above embodiments are intended to be illustrative, and many modifications may be made to the above embodiments by those skilled in this art, and various features described in different embodiments may be freely combined with each other without conflicting in configuration or principle, and these variations are supposed to fall within the scope of protection of the present invention.

Although the present invention is described in conjunction with the accompanying drawings, the embodiments disclosed in the accompanying drawings are intended to exemplify the embodiments of the present invention and are not to be construed as a limitation of the present invention.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

It should be noted that the word “comprising” does not exclude other elements or steps, and the words “one” or “a” do not exclude more than one. Furthermore, any element designation of the claims should not be construed as limiting the scope of the invention.

1. An electrical connection module, comprising:
a strip-shaped insulating plate having a top surface and a bottom surface opposite each other in a height direction and two sides opposite each other in a transverse direction;
a first conductive bar fixed on the top surface of the strip-shaped insulating plate and having two first side strip portions opposite each other in the transverse direction and extending in a longitudinal direction; and
a second conductive bar fixed on the bottom surface of the strip-shaped insulating plate and having two second side strip portions opposite each other in the transverse direction and extending in the longitudinal direction, two transverse sides of the electrical connection module are respectively inserted into two mating connectors, the two first side strip portions are respectively in electrical contact with first elastic terminals of the two mating connectors, and the two second side strip portions are respectively in electrical contact with second elastic terminals of the two mating connectors.

2. The electrical connection module of claim 1, wherein a first mounting groove extending in the longitudinal direction is formed in the top surface of the strip-shaped insulating plate, and the first conductive bar is embedded in the first mounting groove.

3. The electrical connection module of claim 2, wherein a second mounting groove extending in the longitudinal direction is formed in the bottom surface of the strip-shaped insulating plate, and the second conductive bar is embedded in the second mounting groove.

4. The electrical connection module of claim 3, wherein the first conductive bar has a first protrusion between the two first side strip portions and protruding from the first mounting groove, the first protrusion has two first side surfaces opposite each other in the transverse direction, and the two first side surfaces of the first protrusion are perpendicular to the transverse direction and respectively abut against end surfaces of first plugs of the two mating connectors.

5. The electrical connection module of claim 4, wherein the second conductive bar has a second protrusion located between the two second side strip portions and protruding from the second mounting groove, the second protrusion has two second side surfaces opposite each other in the transverse direction, and the two second side surfaces of the second protrusion are perpendicular to the transverse direction and respectively abut against end surfaces of second plugs of the two mating connectors.

6. The electrical connection module of claim 5, wherein a plurality of mounting through holes are formed in each of the strip-shaped insulating plate, the first protrusion of the first conductive bar, and the second protrusion of the second conductive bar, the plurality of mounting through holes are spaced apart in the transverse direction and the longitudinal direction.

7. The electrical connection module of claim 6, further comprising a plurality of insulating cylinders respectively passing through the plurality of mounting through holes, each insulating cylinder has a central through hole allowing one bolt to pass through to enable the electrical connection module to be fastened to an outer shielding shell of a connector by one bolt passing through each insulating cylinder.

8. The electrical connection module of claim 7, wherein the strip-shaped insulating plate electrically isolates the first conductive bar from the second conductive bar, and each insulating cylinder electrically isolates the one bolt passing through each insulating cylinder from the first conductive bar and the second conductive bar.

9. The electrical connection module of claim 7, wherein each insulating cylinder has a flange portion located at one end thereof, the flange portion is positioned on a bottom surface of the second protrusion of the second conductive bar and electrically isolates the second protrusion of the second conductive bar from a bottom wall of the outer shielding shell.

10. The electrical connection module of claim 9, further comprising a plurality of insulating washers located at an other end of each insulating cylinder and positioned on a top surface of the first protrusion of the first conductive bar, the plurality of insulating washers electrically isolate the first protrusion of the first conductive bar from a top wall of the outer shielding shell.

11. The electrical connection module of claim 1, wherein the first conductive bar and the second conductive bar are copper bars or copper alloy bars.

12. A connector, comprising:
an outer shielding shell;
an electrical connection module including a strip-shaped insulating plate, a first conductive bar, and a second conductive bar, the strip-shaped insulating plate has a top surface and a bottom surface opposite each other in a height direction and two sides opposite each other in a transverse direction, the first conductive bar is fixed on the top surface of the strip-shaped insulating plate and has two first side strip portions opposite each other in the transverse direction and extending in a longitudinal direction, the second conductive bar is fixed on the bottom surface of the strip-shaped insulating plate and has two second side strip portions opposite each other in the transverse direction and extending in the longitudinal direction, the electrical connection module is disposed in the outer shielding shell; and
a connecting assembly for fixing the electrical connection module to the outer shielding shell, the outer shielding shell has two side openings opposite each other in a transverse direction thereof to respectively allow insertion of the two mating connectors, two transverse sides of the electrical connection module are respectively inserted into two mating connectors, the two first side strip portions are respectively in electrical contact with first elastic terminals of the two mating connectors, and the two second side strip portions are respectively in electrical contact with second elastic terminals of the two mating connectors.

13. The connector of claim 12, wherein the outer shielding shell has a top wall and a bottom wall opposite each other in a height direction of the outer shielding shell, the first conductive bar and the second conductive bar respectively face the top wall and the bottom wall of the outer shielding shell respectively.

14. The connector of claim 13, wherein the connecting assembly has a plurality of threaded cylinders and a plurality of bolts, the plurality of threaded cylinders are riveted to the top wall of the outer shielding shell, the plurality of bolts respectively pass through the bottom wall of the outer shielding shell and pass through a plurality of insulating cylinders of the electrical connection module, internal threads are formed in each threaded cylinder, the plurality of bolts are respectively threadably connected to the plurality of threaded cylinders to fix the electrical connection module to the outer shielding shell.

15. The connector of claim 14, wherein the plurality of threaded cylinders are respectively inserted into a plurality of insulating washers of the electrical connection module, the insulating washers electrically isolate the threaded cylinders from the first conductive bar and electrically isolate the first conductive bar from the top wall of the outer shielding shell, and a flange portion of each insulating cylinder electrically isolates the second conductive bar from the bottom wall of the outer shielding shell.

16. The connector of claim 13, further comprising two upper insulators and two lower insulators, the two upper insulators are disposed in the outer shielding shell and fixed to an inner side of the top wall of the outer shielding shell, and the two lower insulators are disposed in the outer shielding shell and fixed to an inner side of a bottom wall of the outer shielding shell, the two upper insulators respectively face two first side strip portions of the first conductive bar, a first slot allowing insertion of a first plug of each mating connector is defined between one first side strip portion of the first conductive bar and one upper insulator facing the first side strip portion, and the two lower insulators respectively face two second side strip portions of the second conductive bar, and a second slot allowing the insertion of a second plug of each mating connector is defined between one second side strip portion of the second conductive bar and one lower insulator facing the second side strip portion.

17. The connector of claim 16, wherein a first guide bevel is formed on each of an upper side edge of the strip-shaped insulating plate and each upper insulator, the first guide bevels define a first flared inlet which is open toward an outside to guide the insertion of the first plug of one mating connector into the first slot.

18. The connector of claim 16, wherein a second guide bevel is formed on each of a lower side edge of the strip-shaped insulating plate and each lower insulator, the second guide bevels define a second flared inlet which is open toward an outside to guide the insertion of the second plug of one mating connector into the second slot.

19. The connector of claim 16, wherein each upper insulator is fixed to the inner side of the top wall of the outer shielding shell by screws of a plurality of screws, and each lower insulator is fixed to the inner side of the bottom wall of the outer shielding shell by screws of the plurality of screws.
